(19) United States
(12) Patent Application Publication
(10) Pub. No.: US 2021/0361090 A1
(43) Pub. Date: Nov. 25, 2021

(54) SCARF FRAME USING MAGNETS

(71) Applicant: Won Kyung HONG, Goyang-si (KR)

(72) Inventor: Won Kyung HONG, Goyang-si (KR)

(21) Appl. No.: 17/290,423

(22) PCT Filed: May 26, 2020
(86) PCT No.: PCT/KR2020/006779

§ 371 Date: Apr. 30, 2021

(30) Foreign Application Priority Data
May 27, 2019 (KR) 20-2019-0002158

(51) Int. Cl. A47G 1/06

(52) U.S. Cl. CPC A47G 1/06; A47G 2001/0672

(57) ABSTRACT

When a fabric exhibit is displayed in a general frame, technical assistance is necessary in installation and it is impossible to reuse the exhibit in some cases. Disclosed is a frame configured to remedy the above inconvenience so as to easily attach or detach a fabric exhibit to or from a rear portion of a frame component using a magnetic strip. The frame includes a frame component having a groove formed in a rear portion thereof into which a magnetic strip is inserted in a longitudinal direction, the magnetic strip inserted into the groove of the frame component, and a fixing magnetic strip configured to correspondingly fix the fabric exhibit with the magnetic strip inserted into the groove of the frame component.

### BACKGROUND

### 1. Field of the Invention

The present invention relates to a frame configured to fix a fabric or textile exhibit such as a scarf and the like (hereinafter, referred to as a fabric exhibit) using magnets to easily attach and replace the fabric or textile exhibit without damage.

### 2. Discussion of Related Art

Frames are configured to display or accommodate calligraphic works, photos, or the like and each include a quadrangular framework, a transparent front panel (glass, transparent acrylic panel, or the like), a rear panel, and the like. Generally, objects displayed in frames include paintings, photos, and the like. However, the number of cases in which a fabric exhibit, such as a scarf, is fixed in a frame to be displayed has increased. In a general frame structure, when a fabric exhibit is inserted between transparent acrylic panels to be displayed, it is difficult to fix the fabric exhibit between acrylic panels without wrinkles. When the fabric exhibit is attached to an additional intermediate panel using an adhesive to prevent the exhibit from being wrinkled, it is impossible to reuse the fabric exhibit. Also, since it is difficult to install a fabric exhibit in a frame and to replace the exhibit, technical assistance is necessary.

### SUMMARY OF THE INVENTION

As described above, when a fabric exhibit is displayed using a general frame, not only is technical assistance necessary in order to display the fabric exhibit without wrinkles but also it is difficult to separate the exhibit from the frame to be reused. The present invention is directed to providing a frame in which a fabric exhibit is easily attachable or detachable, replaceable, and reusable.

According to an aspect of the present invention, there is provided a frame including a frame component having a groove formed in a rear portion in a longitudinal direction, a magnetic strip to be inserted into the groove, and another magnetic strip correspondingly attached to the inserted magnetic strip through a magnetic force to fix a fabric exhibit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a rear view of a frame according to one embodiment of the present invention;

FIG. 2 is a cross-sectional view of a frame component taken along line A-A shown in FIG. 1;

FIG. 3 is a rear perspective view of the frame according to one embodiment of the present invention;

FIG. 4 is a rear view illustrating an example in which an exhibit is installed in the frame according to one embodiment of the present invention; and

FIG. 5 is a front view of the example of FIG. 4.

### DETAILED DESCRIPTION OF EXEMPLARY EMBODIMENTS

One exemplary embodiment of the present invention provides a frame in which a fabric exhibit is fixed to be attachable to or detachable from the frame rearwards using a magnetic strip fixed to a rear surface of a frame component and a fixing magnetic strip paired therewith. Accordingly, the frame according to one exemplary embodiment of the present invention includes four frame components formed of magnetic strips inserted into grooves formed in sides of a rear portion in a longitudinal direction and four other magnetic strips configured to be paired therewith and to fix the exhibit using magnetic forces. Hereinafter, the frame according to one exemplary embodiment of the present invention will be described with reference to the attached drawings.

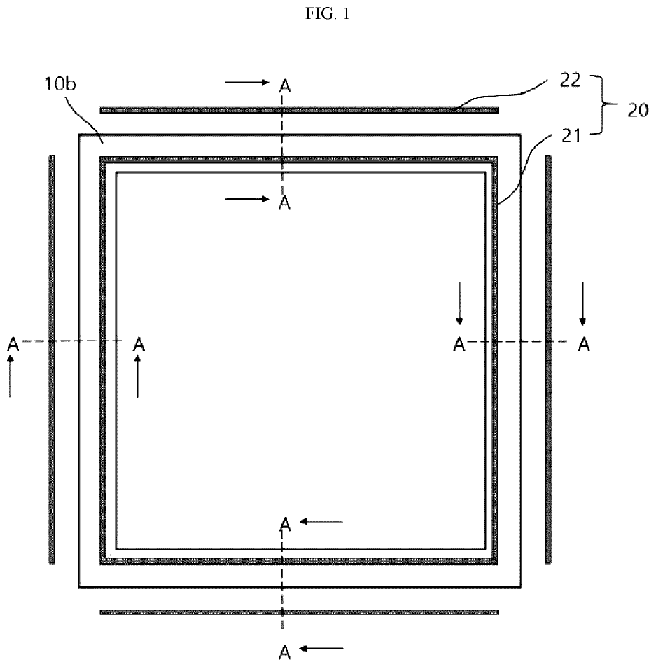

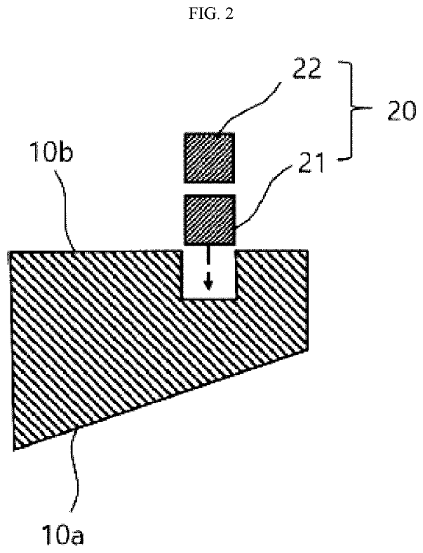

FIG. 1 is a rear view of a frame according to one embodiment of the present invention, and FIG. 2 is a cross-sectional view of a frame component taken along line A-A of FIG. 1. As shown in FIG. 1, a magnetic strip is inserted into and fixed to a groove formed in a rear portion of the frame component in a longitudinal direction and a fixing magnetic strip paired with the inserted and fixed magnetic strip to fix an exhibit, which form a pair, so that four pairs of frame components are included in one frame.

With respect to a method of inserting and fixing the magnetic strip into and to the frame component, since any one of wood, plastic, metallic material, and the like is applicable to the frame component, a method of forming the groove in the frame component and a method of fixing the magnetic strip thereto may vary according to a material and property of the frame component. As the magnetic strips, it is possible to generally use magnetic strips for a refrigerator or an insect-proof net which are currently on the market and a shape, size, material, and the like thereof are not limited thereto.

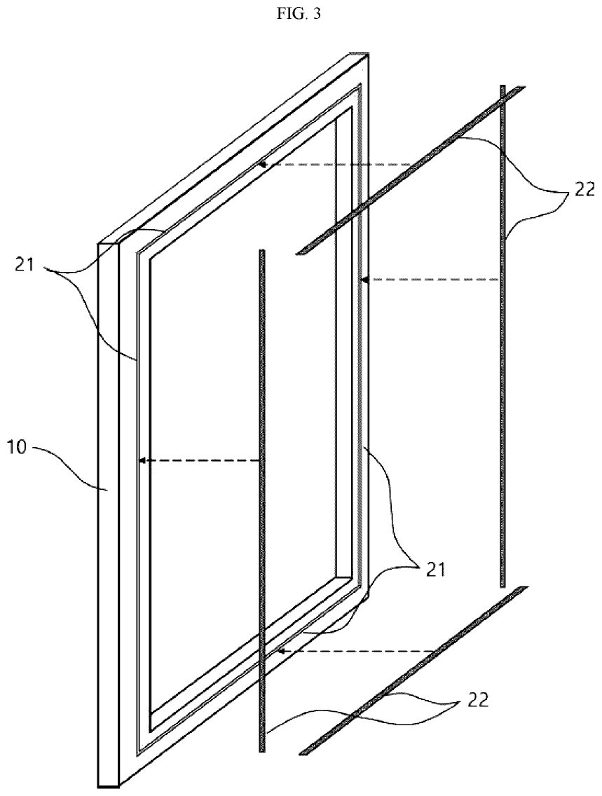

FIG. 3 is a rear perspective view of the frame according to one embodiment of the present invention that illustrates how the magnetic strip fixed to each frame component and the fixing magnetic strip correspond to each other and fix a fabric exhibit.

Respective sides of the fabric exhibit are disposed on a rear portion of the frame according to one embodiment of the present invention to be parallel to and to cover the magnetic strips in the frame components therebelow, and the fixing magnetic strips are disposed on the fabric exhibit to correspond to the magnetic strips in the frame components so that the fabric exhibit is fixed using mutual magnetic forces.

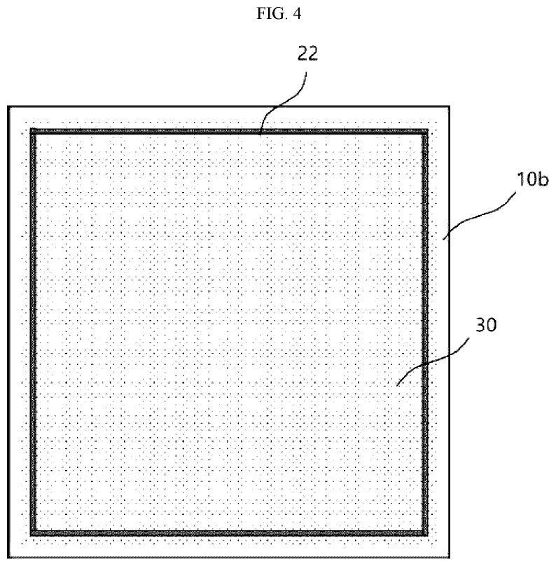

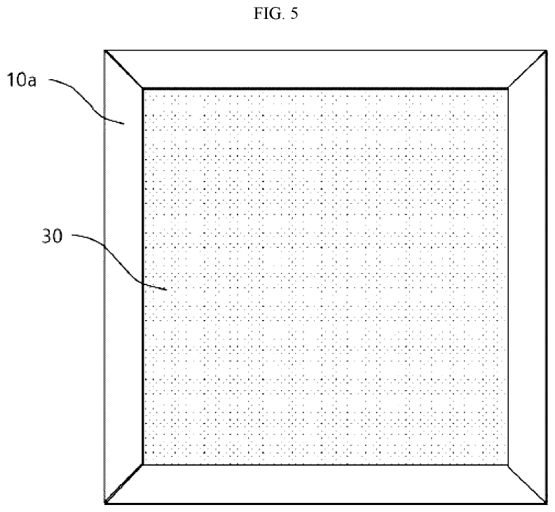

FIG. 4 illustrates an example in which the fabric exhibit is attached to the frame according to one embodiment of the present invention, and FIG. 5 is a front view of the example of FIG. 4.

The frame according to the embodiments of the present invention provides advantages as follows.

First, a fabric exhibit may be easily replaced through attachment or detachment using a fixing magnetic string.

Second, since it is unnecessary to use an adhesive or the like to fix a fabric exhibit (for example, a scarf) to an intermediate panel or the like, the fabric exhibit may be reused.

Third, a fabric exhibit may be displayed without wrinkles or damage.

Although the exemplary embodiment of the present invention has been described above, the present invention is not limited thereto. Also, it is apparent to one of ordinary skill in the art that a variety of changes and modifications may be made without departing from the technical concept of the present invention and equivalents of the following claim.

A mode for implementing the present invention has been described above in the best mode for implementing the present invention.

The present invention relates to fixing magnetic strips configured to fix a fabric exhibit, which is applicable to a frame and has repeatability so as to have industrial applicability.

What is claimed is:

1. A frame comprising:
a frame component (10) having a groove formed in a longitudinal direction in a rear portion (10b) of the frame component;
a magnetic strip (21) inserted into and fixed to the groove of the rear portion (10b) of the frame component; and
a fixing magnetic strip (22) attached to the magnetic strip (21) inserted into the rear portion (10b) of the frame component through a magnetic force so as to fix a fabric exhibit (30) interposed at a position in contact with the magnetic strip (21),
wherein the groove formed in the rear portion (10b) of the frame component is continuously formed along respective sides included in the frame component so as to have a closed plane figure structure that is a quadrangular structure recessed to a certain depth in a side cross-sectional view,
wherein the magnetic strip (21) has a cross-sectional structure corresponding to a cross-sectional structure of the groove formed in the rear portion (10b) of the frame component, has a structure extending lengthwise corresponding to the longitudinal direction in which the groove extends, and is inserted into and fixed to the groove so as to form one closed plane figure structure, and
wherein the fixing magnetic strip (22) has the same cross-sectional structure as that of the magnetic strip (21), has a structure extending lengthwise corresponding to the longitudinal direction in which the magnetic strip (21) extends, and is attached to the magnetic strip (21) through a magnetic force so as to form a closed plane figure structure.
